(19) United States
(12) Patent Application Publication
(10) Pub. No.: US 2025/0298500 A1
(43) Pub. Date: Sep. 25, 2025

(54) TRACKING PROVENANCE OF CONTENT FROM A GENERATIVE MODEL

(71) Applicant: Microsoft Technology Licensing, LLC, Redmond, WA (US)

(72) Inventors: Eric J. HORVITZ, Portola Valley, CA (US); Paul ENGLAND, Bellevue, WA (US); Patrick W.J. EVANS, Fall City, WA (US)

(73) Assignee: Microsoft Technology Licensing, LLC, Redmond, WA (US)

(21) Appl. No.: 18/614,566

(22) Filed: Mar. 22, 2024

(51) Int. Cl. G06F 3/04845; G06F 3/04817; G06F 3/14; H04L 9/32

(52) U.S. Cl. CPC G06F 3/04845; G06F 3/04817; G06F 3/14; H04L 9/3247

(57) ABSTRACT

A computing system is provided that includes processing circuitry and associated memory. The processing circuitry is configured to implement a program using portions of the associated memory, to receive, via an edit operation, digital content and provenance metadata associated with the digital content. The processing circuitry implementing the program is further configured to determine, via a provenance determination module, that a textual portion of the digital content is model-generated and originated from a generative model, based on the provenance metadata, and output the digital content to a graphical user interface with a visual indication that the textual portion of the digital content is model-generated.

### BACKGROUND

Generative models are machine learning models that are trained to create digital content, such as computer generated text and images. Recently, large language models (LLMs) and multi-modal models based on generative pre-trained transformers have been developed that produce increasingly useful and human-like output. These models have achieved widespread adoption and the digital content generated by these generative models is increasing rapidly. As a result, many users encounter model-generated content in their daily lives from many different sources. When a user directly interacts with such a model, the user can easily understand they are viewing model-generated content. However, when a user encounters model-generated content that appears in other locations, such as in a document authored by other persons, the user may be completely unaware that the content was generated by a generative model. A technical challenge exists in determining the provenance of such digital content and identifying whether it originates from a digital model, and tracking that provenance as the digital content is manipulated by users via edit operations.

### SUMMARY

To address the above issues, a computing system is provided that includes processing circuitry and associated memory. The processing circuitry is configured to implement a program using portions of the associated memory, to receive, via an edit operation, digital content and provenance metadata associated with the digital content. The processing circuitry implementing the program is further configured to determine, via a provenance determination module, that a textual portion of the digital content is model-generated and originated from a generative model, based on the provenance metadata, and output the digital content to a graphical user interface with a visual indication that the textual portion of the digital content is model-generated.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 schematically shows a computing system for use in determining provenance of digital content from a generative model.

FIG. 2 schematically shows additional examples of graphical user interfaces of the computing system of FIG. 1.

FIG. 3 schematically shows a detailed view of the computing system of FIGS. 1-2, including an implementation of a provenance determination module on a client computing device that receives model-generated digital content and provenance metadata from a generative model at a server computing device directly, or via a model interface executed at an intermediate server computing device.

FIG. 4 is a detailed schematic illustration of an example implementation of the provenance metadata generation module of FIG. 3.

FIG. 5 shows an exemplary interaction with a graphical user interface of a program capable of receiving provenance-tracked content, using the computing system of FIGS. 1-4.

FIG. 6 illustrates an exemplary interaction using the computing system of FIGS. 1-5, further illustration a regeneration option.

FIGS. 7A, 7B, and 7C illustrate, respectively, character encoding examples used by the computing system of FIGS. 1-6, where no bit is set to indicate a model-generated character (FIG. 7A), a code plane bit is set to indicate a model-generated character (FIG. 7B), and a code page bit is set to indicate a model-generated character (FIG. 7C).

FIG. 8A illustrates an allocation of Unicode code points and a relationship between code pages and code planes, of FIGS. 7A-7C.

FIG. 8B illustrates an allocation of high and low surrogate code points within the Basic Multilingual Plane (BMP) of the Unicode allocation shown in FIG. 8A.

FIG. 9 shows a flow diagram for an example method for use in determining provenance of digital content from a generative model.

FIGS. 10A and 10B show a flow diagram for an example method for receiving digital content and provenance metadata associated with the digital content, and outputting the digital content with indications of the textual characters that are model generated, according to another example of the present disclosure.

FIG. 10C shows a flow diagram for an example method for generating provenance metadata associated with digital content where the provenance metadata includes indications whether each character is model-generated, and outputting the digital content and provenance metadata associated with the digital content, according to another example of the present disclosure.

FIG. 11 shows a schematic view of an example computing environment in which the computing system of FIGS. 1-8 and the methods of FIGS. 9 and 10A-10C may be enacted.

### DETAILED DESCRIPTION

The identification of model-generated content generated via generative models, in particular, generative large language models (LLMs), that produce human-like text presents a technical challenge. Generative models have improved dramatically in recent years, and the digital content provided by such models can be difficult or impossible to distinguish from human- or user-generated content using conventional techniques. For example, one existing technique uses a classifier to analyze text for word patterns that often occur in AI-generated text. However, the use of such a classifier is problematic since generative models are constantly being improved and their output is becoming more human-like. In addition, classifiers developed for the purpose of detecting AI-generated text can be employed as part of the training and refinement of AI text generators via an optimization process that shapes the generators into generating text that is difficult to detect. Further, such classifiers may become more difficult to develop as there is the potential for model collapse scenarios in which training data for such classifiers is polluted by the output of generative models. Model collapse could occur if training data includes too much data that is supposed to be human generated but is actually AI generated. A classifier trained on such a polluted training data set would suffer a loss in prediction accuracy.

Several techniques have been proposed for tracking AI generated content, including AI watermarking techniques that insert special characters or word patterns into AI output, and digitally signed and encrypted manifest techniques that create a secure manifest containing attestations for AI content contained in an associated file. However, such approaches to attaching provenance information or marking with stenographic watermarks do not address the technical challenges of tracking AI content when a user incorporates AI content into documents created using productivity applications, such as word processors, spreadsheet programs, slide deck presentation software, email and messaging applications, etc. in the absence of watermarking and provenance machinery- or when the applications or post-processing enables the stripping of the identifying content. One particular challenge is that during edit operations in which a portion of AI generated content is incorporated into a new document, AI watermark or provenance information can be lost, truncated, or misinterpreted. Another challenge is that information from different AI sources may use different and incompatible AI watermarking or manifest techniques. Another challenge and need is to track and understand AI versus human-generated content or human-edits to note and track attribution of input and creativity. As such, a digital artifact such as a document may have multiple AI-based and human contributions and refinements, which are dispersed throughout where different portions of text have unique histories of edits and refinements.

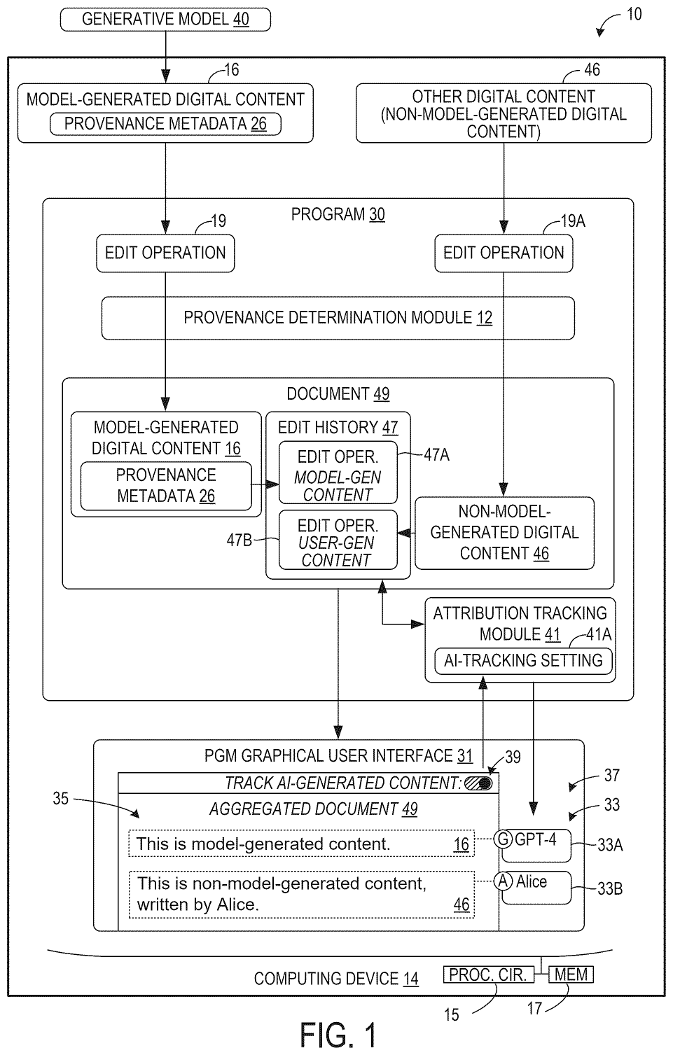

To address these issues, FIG. 1 schematically shows a computing system 10 for use in determining provenance of model-generated digital content 16 from a generative model 40, according to one embodiment of the present disclosure. Computing system 10 includes a computing device 14 including processing circuitry 15 and associated memory 17. The processing circuitry 15 is configured to implement a program 30 using portions of memory 17 to receive, via an edit operation 19, model-generated digital content 16 and provenance metadata 26 associated with the model-generated digital content. The edit operation may be a copy and paste, cut and paste, insert, import, file open, or other operation that causes content from the generative model to be received by the program 30 and incorporated into a document 49. The document 49 may be a word processing document, slide presentation, spreadsheet, web page, email or other message, drawing, social media post, etc., created by the user using the program 30. Typically, a user who is using the program 30 performs the edit operation 19, although in some cases the edit operation 19 may be performed programmatically by the program 30. The user may be an authenticated user who has been authenticated and granted access privileges to execute the program 30 by an access control system of an operating system of the computing device 14.

The document 49 may include both model-generated digital content and other digital content 16 that is not model generated aggregated in a single document 49, referred to as an aggregated document 49. In response to a user command, the program is configured to receive the model-generated digital content and incorporate it into the aggregated document 49 via the edit operation 19. The edit operation 19 is recorded in a first entry 47A in an edit history 47 associated with the aggregated document 49. Further, in response to another user command to perform another edit operation 19A, the program is configured to receive other digital content 46 that is not model generated (i.e., non-model generated content) and incorporate it in the aggregated document 49. The edit operation 19A incorporating the non-model generated content 46 into the aggregated document 49 is also recorded as a second entry 47B in the edit history 47.

Program 30 is further configured to determine, via a provenance determination module 12, that the model-generated digital content 16 is model-generated and originates from generative model 40 based on the provenance metadata 26. Detailed techniques for making this determination are described below. Upon making this determination, the program 30 is configured to output the model-generated digital content 16 to a program graphical user interface 31 with a visual indication 33 that the model-generated digital content 16 is model-generated. To keep track of the various edit operations made to document 49, program 30 includes an attribution tracking module 41 configured to attribute edit operations in an edit history 47 to users who performed the edit operations. Each edit operation is listed as an entry in the edit history 47, and includes the text inserted or deleted, the user making the edit operation, the time of the edit operation, etc. The attribution tracking module can be configured to authorship not only to users, but also to generative models. To accomplish this, an AI tracking setting 41A can be set by a user to instruct the attribution tracking module 41 to selectively track or not track model-generated content included in the document 49 via edit operations 19, as described below.

In addition to model-generated digital content 16, the program 30 is also configured to receive other digital content 46, which may be non-model generated content authored by a user, for example. Following receipt of the other digital content 46, the program 30 is configured to determine, via the provenance determination module 12, that a textual portion of other digital content 46 is not model-generated. Upon making this determination, the program is configured to output the other digital content 46 in a visually distinctive manner to the displayed model-generated content. In FIG. 1, model-generated content 46 from a GPT-4 model and other digital content 46 from Alice are displayed in the program graphical user interface 31, and the use of differently labeled icons (GPT-4 vs. Alice) is the visually distinctive manner. Various other forms of visual distinction can be employed, such as different colors, fonts, highlighting, bounding boxes, underlining, side bars, etc., as discussed below.

The program graphical user interface 31 includes a document region 35 and a review region 37. The model-generated content 16 and the non-model generated content 46 are displayed in the document region 35. A model-generated icon 33A, labeled with the name (GPT-4) of generative model 40, is displayed in the review region 37 adjacent the model-generated content 16 in the document region 35. Further, a non-model generated icon 33B, labeled with the user (Alice) who authored the non-model generated content 46, is displayed in the review region 37 adjacent to the non-model generated content 46 in the document region 35.

The program graphical user interface 31 includes a selector 39 configured to receive a user input to selectively enable and disable tracking of model-generated content. The selector 39 is illustrated by way of example as a button with on and off positions, but may take various other forms. When the user clicks or presses selector 39 to activate tracking of model-generated content, the AI-tracking setting 41A of the attribution tracking module is set to YES, to enable tracking of model-generated content in the manner described above using the provenance determination module 12. If the setting is set to NO, then edit operations including model-generate digital content 16 are included in the edit history without any indication that the content of the edit operation originated from generative model 40, only that it originated from a user.

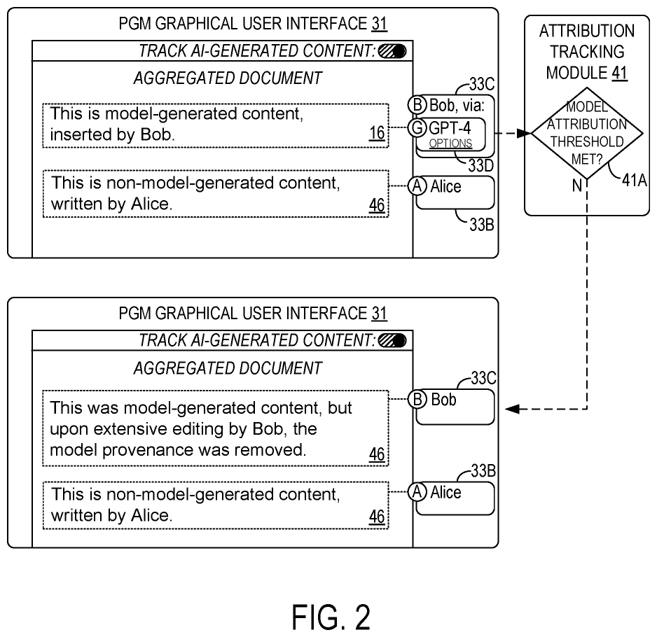

As shown in FIG. 2, the attribution tracking module 41 can be configured to attribute the model-generated digital content 16 to a user who performed the edit operation 19 via which the model-generated digital content 16 was received and incorporated into the aggregated document 49. For example, suppose that Bob is an authenticated user of the computing device 14, and Bob performed the edit operation 19 (e.g., a copy/paste operation) and copied in the model-generated digital content 16 from a GPT-4 model as generative model 40. In such a case, a user icon 33C is displayed adjacent the model icon 33D, to indicate that Bob was the user who performed the edit operation 19 that copied in the GPT-4 generated content.

The attribution tracking module 41 can be configured with a model attribution threshold. Further, the attribution tracking module 41 can be configured to remove a model generated attribution of the model-generated digital content 16 upon determining that the model generated digital content 16 has been edited to an extent that the model attribution threshold is no longer met (N at 41A). In the depicted example at the bottom of FIG. 2, Bob has extensively edited the model-generated digital content 16 to be sufficiently dissimilar to the original model generated content as to have the model attribution removed. Thus, only Bob's name appears in attribution icon 33C, and model icon 33D is not displayed. Further, a corresponding entry in the edit history 47 (see FIG. 1) would be modified to remove the model attribution, and the text would henceforth treated by program 30 as non-model generated digital content 46. The model attribution threshold defines a degree to which the model-generated digital content 16 must retain its integrity to be classified as model-generated digital content. In one example, the model attribution threshold can be a number of edits. In another example, the model attribution threshold can be a percentage or density of model-generated words or characters retained following user edits as compared to the originally received model-generated content. In yet another example, the model attribution threshold can be a textual similarity score between the original model-generated digital content received by the program and the edited version of it after being edited by a user or users. As an alternative to utilization of a model attribution threshold, the attribution tracking module 41 may be configured to retain the full edit history 47 and indicate attribution not based on an attribution threshold as describe above, but rather directly based on the information in the full edit history 47. With this approach, a user can see the exact human user or model source for a particular piece content, even after complex editing has occurred. Exact attribution based on the full edit history can be indicated even for short snippets of text, for example on a character by character basis if desired.

Techniques for determining the provenance of the model generated content will now be described in greater detail. Devices and methods are discussed below that enable tracking of the provenance of model-generated content (e.g., generative LLM character strings and multi-modal content including such strings) using, for example, Unicode or similar encoding schemes to identify which characters in a digital content are model-generated. In one example, each character is encoded so as to effectively create a mirror of a commonly used Unicode code point with an AI-specific tag or encoding that indicates a model-generated character. Leveraging this encoding, an application program can identify AI-generated content via the encodings yet continue to render and handle the content in a manner that is compatible with and does not interfere with character rendering by existing software programs. Notably, this encoding method does not add additional characters, such as markup tags to the model-generated text. This has the technical advantage of improved interoperability with existing programs not configured to recognize such tags, and also prevents interference that such tags may cause when used as training data text for other AI models. The identification of model-generated content in the described manner allows for filtering of AI content, identification of AI-generated content in non-AI contexts and intermixed with user-generated/non-AI-generated content, and verification processes for content of unknown origin. In addition or as an alternative, a manifest based approach to encoding attestations of model provenance in a digitally signed and encrypted manifest file may be used to represent and store the provenance metadata.

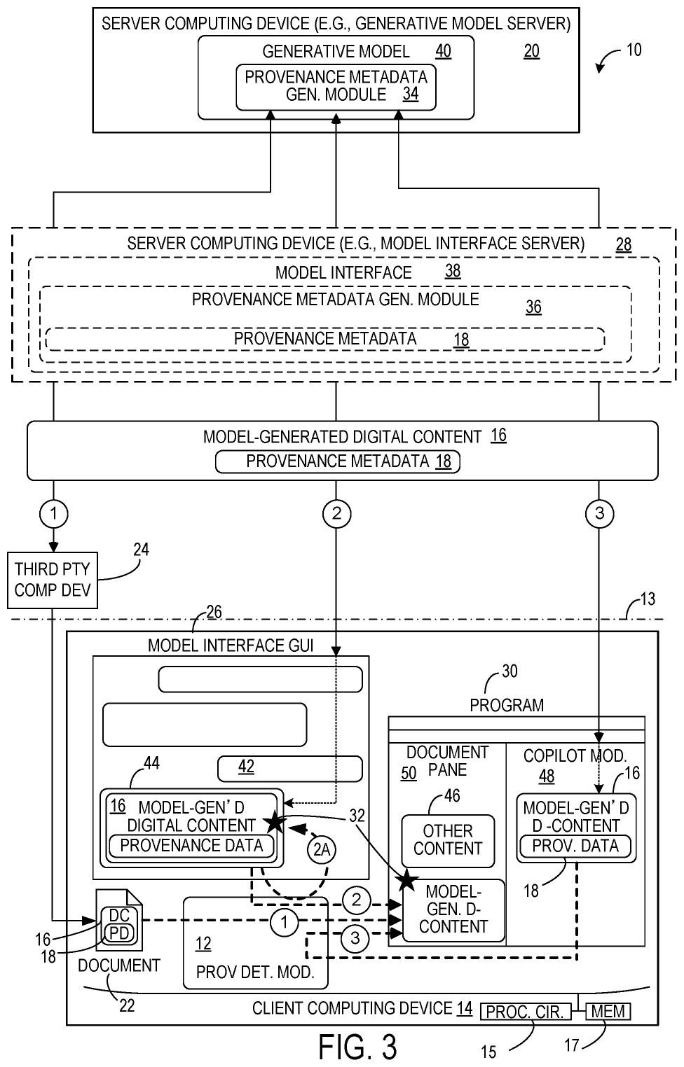

FIG. 3 schematically shows a detailed view of computing system 10 including client computing device 14 and a server computing device 20 configured to communicate with the client computing device 14 via a communication network 13. In some configurations explained in more detail below, the computing system 10 may include a server computing device 28 connected to network 13 and configured to act as an interface between the server computing device 28 and client computing device 14.

The computing system 10 features an implementation of provenance determination module 12 on client computing device 14 for receiving model-generated digital content 16 and provenance metadata 18 associated with the digital content from the server computing device 20, according to an exemplary embodiment. In other configurations, the provenance determination module 12 can be executed on the server computing device 28, or other computing device.

FIG. 3 also shows that the computing system 10 comprises processing circuitry 15 and associated memory 17 as described above, the processing circuitry 15 being configured to implement provenance determination module 12, to receive digital content 16 and provenance metadata 18 associated with the digital content. The content may be received, for example, via a first pathway shown at (1), corresponding to model-generated digital content 16 in a document 22 received by program 30 from a third party computing device 24), or via a second pathway shown at (2), corresponding to model-generated digital content 16 received first by a model interface graphical user interface (GUI) 26 from a model interface server 28 or generative model server 20 and then by program 30, or via a third pathway shown at (3), corresponding to model-generated digital content 16 received by a program 30 via a copilot module 48 of program 30. Other pathways for receipt of the digital content by program 30 may also be provided.

The processing circuitry 15 may also be configured to determine, on a per-character basis, whether each of a plurality of textual characters in the digital content 16 is model-generated based on the provenance metadata 18, and output the digital content 18 with indications (e.g., character encoding with an AI indicator) of the textual characters that are model-generated. As shown, the processing circuitry 15 and memory 17 may be incorporated in a client computing device 14, and the provenance metadata 18 may be generated by a provenance metadata generation module 34 or 36 executed on a server computing device 20 or 28, from which the digital content was received. Also as shown, the server computing device may comprise a generative model server 20, or the server computing device may comprise a model interface server 28 configured to execute a model interface 38, the model interface 38 being configured to interface with the generative model 40 on the generative model server 20.

For example, in the first pathway (1), document 22 may be an external document that includes digital content 16 along with provenance metadata 18 (for AI-generated characters in the document). The document 22 may be saved in one of a variety of formats, including a word processing format, email or message format, a spreadsheet format, a database file format, a drawing format, a presentation format, a notepad format, etc.), and the provenance metadata 18 may be included in the file format. The document 22 may be received by program 30, which may be, for example, a productivity program such as a word processor program, email or messaging program, spreadsheet program, database program, drawing program, presentation generation program, notepad program, etc. The program 30 may receive the document 22 by opening the document, converting the document via an insertion tool, via a copy/paste (or cut/paste) operation carried out via a system clipboard, or some other transfer of the document information from another program. The document 22 may be sent by third party computing device 24 over computing network 13 to client computing device 14, and stored in the memory of client computing device 13 prior to being received program 30.

As illustrated in FIG. 3, the first pathway (1) for receiving the digital content with provenance metadata 18, includes the third party computing device 24 receiving the model-generated digital content 16 with associated provenance metadata 18 via a generative model server 20 or a model interface server 28, either of which may have received provenance metadata 18 from a provenance metadata generation module 34 or 36. Also, as shown, a provenance determination module 12 may receive the model-generated digital content 16 with associated provenance metadata 18 via the document 22, determine, for example on a per-character basis, whether each of a plurality of textual characters in the digital content 16 is model-generated based on the provenance metadata 18, and output the digital content 18 with indications (e.g., character encoding with an AI indicator) of the textual characters that are model-generated.

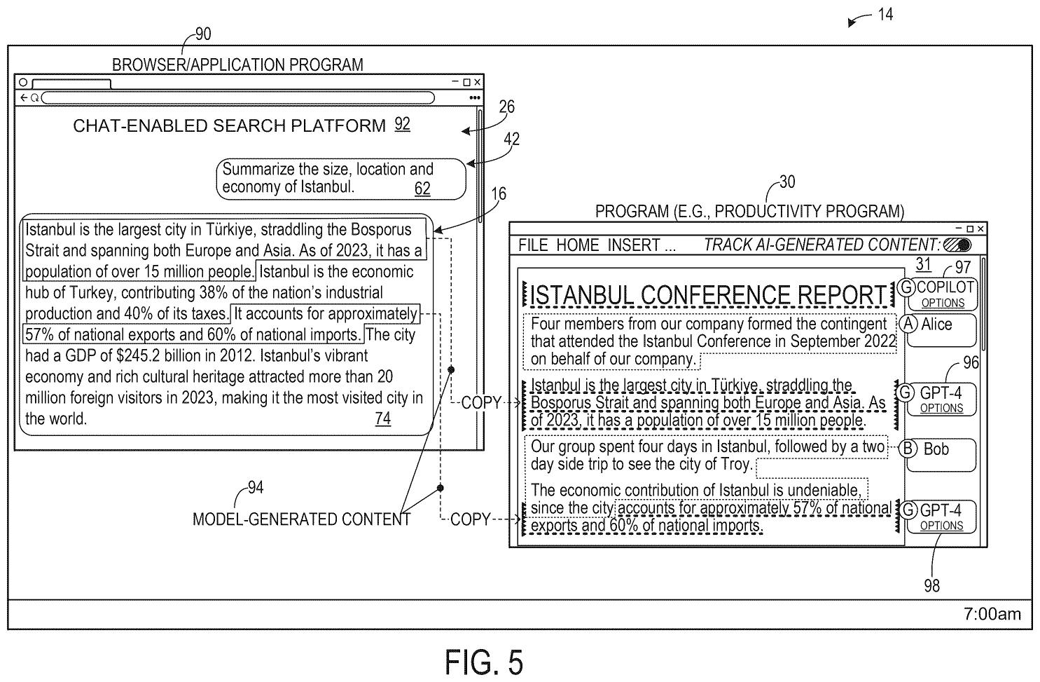

In a second pathway (2), a model interface GUI 26 executed on a client computing device 14 may be in communication with generative model server 20 directly or via a model interface server 28, to receive model-generated digital content 16 with associated provenance metadata 18, in response to one or more prompts 42 communicated from the model interface GUI 26 to the model interface server 28 or generative model server 20. In the example illustrated in FIG. 3, one or more prompts 42 inputted by a user into a turn-based chatbot interface are sent directly or indirectly via model interface server 28 to generative model 40. The prompts 42, when inputted into the generative model 40 executed the server computing device 20, causes the generative model 40 to output model-generated digital content 16. The model generated digital content is returned to the client computing device 14 and displayed at the model interface GUI 26 in dialogue box 44. A provenance metadata generation module 34, 36 is configured to generate provenance metadata 18, which is also sent from server computing device 20 or server computing device 28 to the client computing device 14. As shown, a provenance determination module 12 may receive the model-generated digital content 16 with associated provenance metadata 18 via the dialogue box 44 (or via a clipboard or cut/paste or copy/paste function from the model interface GUI 26), determine, for example on a per-character basis, whether each of the plurality of textual characters in the digital content 16 copied from the model interface GUI is model-generated based on the provenance metadata 18, and output, via a paste function to the destination program 30 the digital content 18 with indications of the textual characters that are model-generated, examples of which are shown at 96 and 98 in FIG. 5 described below.

In a third pathway (3), a copilot AI module 48 (e.g., configured as a chatbot) of program 30 executed on the client computing device 14 may be in communication with the generative model server 20 either directly or indirectly via the model interface server 28, to receive model-generated digital content 16 with associated provenance metadata 18. As shown, the provenance determination module 12 may receive the model-generated digital content 16 with associated provenance metadata 18 from the copilot AI module 48 of the program 30. Similar to the process described for pathways (1) and (2) above, the provenance determination module 12 is configured upon receipt from the copilot module 48 to determine, for example on a per-character basis, whether each of a plurality of textual characters in the digital content 16 is model-generated based on the provenance metadata 18, and output the digital content 18 with indications (see, e.g., 96 and 98 in FIG. 5) of the textual characters that are model-generated. For example, as shown, the provenance determination module 12 may provide the model-generated digital content 16 for display with visual provenance indication 32 on a document pane 50 of the program 30, or at another location such as in the pane of the copilot module 48.

Other pathways may be used, in addition to those discussed above or illustrated with respect to FIG. 3. As one example, the provenance metadata generation module 36 and the provenance metadata determination module 12 may be executed on a same device. In other examples, the model interface 38 and the generative model 40 may be executed on a same server computing device. Further, it will be appreciated that the form of the client computing device is not limited, and thus the pathways may traverse smartphone or tablet computing devices as the client computing device, in addition to desktop, laptop or other computing devices. The provenance determination module 12 may be implemented as a portion of program 30, a service of an operating system of the client computing device, a web service, a portion of the browser implementing the model interface GUI 26, a portion of the copilot module 48, etc.

Continuing with FIG. 3, the provenance determination module 12 may further be configured to output the digital content 16 with indications (e.g., 33A, 33B in FIG. 1, 33D in FIG. 2, 96, 97, 98 in FIG. 5) of the textual characters that are model-generated, at least in part by formatting the digital content for display using the provenance metadata 18, with the formatted digital content including a visual provenance indication, schematically indicated in FIG. 3 as 32, labeling the model-generated portion of the digital content, and outputting the formatted digital content including the visual provenance indication 32 to a display. The visual provenance indication 32 is shown as a star in FIG. 3, but it will be appreciated that this is a schematic illustration and the actual graphical appearance of the indication 32 is not so limited. As a few examples, the indication 32 may include forms of emphasis such as highlighting, underlining, sidebars, comment bubbles, bold, italic, redlining (or other font color), text box, font size, font, etc., of the content determined to be model-generated. Typically, these indications are displayed on a per-character basis, to visually indicate which characters are model generated. For example, “Hello world\0” may be a model-generated string. In one embodiment, each of the characters spelling out the words HELLO WORLD, including the space between the two words, may include encoding that, when interpreted by a destination program capable of receiving provenance-tracked content, permits rendering the characters to appear highlighted or underlined, or highlighted and/or underlined, along with a visual message that pops up indicated the (highlighted and/or underlined) characters are model-generated. In another example, a user (such as user of the provenance-tracking capable program 30) may add other content 46 such that the string becomes “Hello world, my name is Bob.\0”, which is a combination of model-generated content (i.e., the characters in the string “Hello world\0”) and human/user-generated content (i.e., the characters in the string “, my name is Bob.\0”). In one example, the model-generated content may be highlighted (with a pop up indication that the characters are model-generated) and the user-generated content may be underlined.

The provenance determination module 12 may be configured to receive the digital content from a copilot module 48 provided in a productivity application 30, a browser, a social media application, or a game program executed by the processing circuitry, an instance of a generative model 40 associated with a model interface GUI 26 displayed by the processing circuitry, a model interface 38 associated with the model interface GUI 26 displayed by the processing circuitry, a clipboard program executed by the processing circuitry, or a document 22.

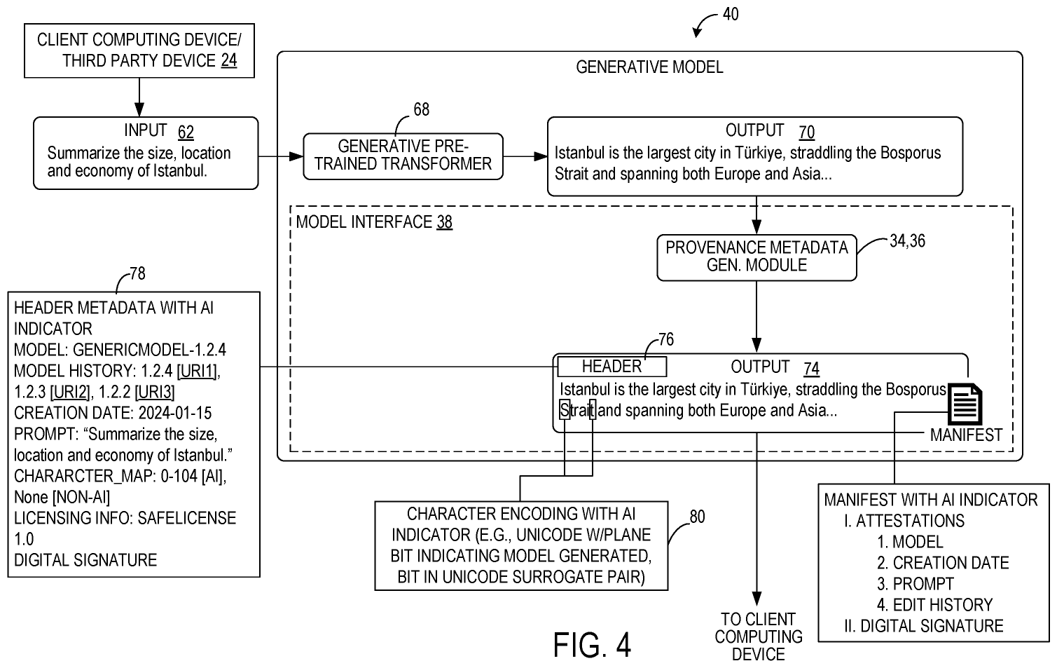

FIG. 4 is a detailed schematic illustration of an example implementation of the generative model 40 of FIGS. 1 and 3. As shown, input 62 may be transmitted from client computing device 14 or third party device 24 to the server computing device 20 executing the generative model 40. The input 62 is typically a prompt such as prompt 42 described above. The generative model 40 may include a generative pre-trained transformer (GPT) 68, which, upon receiving the input 62 produces the as output 70 model-generated digital content 16. It will be appreciated that the generative model can be a LLM having tens of millions to billions of parameters, non-limiting examples of which include GPT-3, BLOOM, and LLaMa-2. The generative model can be a multi-modal generative model configured to receive multi-modal input including natural language text input as a first mode of input and image, video, or audio as a second mode of input, and generate output including natural language text based on the multi-modal input. The output of the multi-modal model may additionally include a second mode of output such as image, video, or audio output. Non-limiting examples of multi-modal generative models include Kosmos-2 and GPT-4 VISUAL. Further, the generative pre-trained transformer 68, can be, for example, the GPT-3, GPT-3.5, or GPT-4 model. Further, the provenance information may indicate not only the general type of model (e.g., GPT-3.5) but the specific model instance and creation date (e.g., gpt-3.5-turbo-0125 Feb. 1, 2024).

In the depicted example, the input 62 reads, “Summarize the size, location and economy of Istanbul.” Further, the model-generated output 70 reads, “Istanbul is the largest city in Türkiye, straddling the Bosporus Strait and spanning both Europe and Asia . . . ” The model-generated output 70 may be received and processed by the provenance metadata generation module 34, 36, to thereby add provenance metadata 18 to the output. The provenance metadata generation module 34, 36 may be provenance metadata generation module 34 implemented on the generative model server 20 or, as shown in dashed lines, may be provenance metadata generation module 36 implemented as part of the model interface 38 executed on model interface server 28.

The output 74 of the provenance metadata generation module 60 may include provenance metadata 18 comprising header metadata 76 that is detectable by the provenance determination module 12 of computing system 10. Alternatively, metadata of another form may be used. The provenance determination module 12 (see FIG. 3) may be configured to make the provenance determination by detecting header metadata 76 of the digital content indicating AI generation, on a per-character basis. Continuing with FIG. 4, the exemplary header metadata with AI indicator 78 includes a character map indicating that characters 0-104 are model-generated (and that none of the output characters are non-AI-generated). Although not shown, the header metadata may include an indication that one or more characters are of non-AI generated and/or of unknown origin, whereby the provenance metadata generation module 60 determined that the provenance of specific characters indicates they are not AI generated or that the origin is unknown.

In one example configuration, the provenance metadata 18 (such as the exemplary header metadata with AI indicator 78) includes a creation date, a model version identifier, and/or prompt used to generate the portion of the digital content. As shown, the exemplary header metadata with AI indicator 78 includes a creation date of “2024-01-15”, a model version identifier specifying the model version used as “GENERICMODEL-1.2.4”, and the prompt used as “Summarize the size, location and economy of Istanbul.” In another embodiment, the provenance metadata 18 may include model version, model history, and/or prompts or prompt-related context used to generate the portions of the digital content generated by a generative model so that the model-generated content may be regenerated or updated. As shown, the exemplary header metadata with AI indicator 78 includes a model history having three different model versions (i.e., “1.2.4”, “1.2.3”, and “1.2.2”), with each model version having an associated URI (i.e., “URI1”, “URI2”, and “URI3”, respectively). In another example, the provenance metadata 18 comprising the model versions and/or associated URI for each model version, along with the prompt used, enables regeneration of the model-generated content (for example, to update data, statistics, etc. at a later date).

The provenance metadata 18 may be encrypted and/or digitally signed and may further include license information. For example, the exemplary header metadata with AI indicator 78 includes example licensing information (i.e., “LICENSING INFO: SAFELICENSE 1.0” and reference to a digital signature. Additionally, the provenance determination module 18 may read attestation data or digital signature data, e.g., included in metadata such as the header metadata 78, and the output 74 comprising the digital content and provenance metadata may be output to a destination program, such as program 30. The provenance determination module 12 may be configured such that outputting, such as shown in FIG. 3, includes providing the provenance metadata 18 and the received digital content 16, with the identified portions of the digital content that were generated by the generative model, to program 30, which is capable of receiving provenance-tracked content.

Also as depicted in FIG. 4, the output 74 of the provenance metadata generation module 60 may comprise provenance metadata 18 that includes a character encoding 80 that encodes the model-generated indication on a per-character basis. The provenance metadata 18 may include character encoding 80 with an AI indicator. The provenance metadata 18 may include surrogate character encoding or Unicode code plane encoding indicating a model-generated character. For example, the AI indicator may include a Unicode encoding with one or more code plane or code page bit flipped (or set) indicating the particular character is model-generated, or the AI indicator may include one or more bits in a Unicode surrogate pair (as discussed below in greater detail with respect to FIGS. 4B and 5B). The provenance determination module 12 may be configured to make the provenance determination by detecting the character encoding 80 indicative of text originating from a generative model, on a per-character basis. Alternatively to a per-character basis, two or more surrounding surrogates in a single string could be utilized to indicate model-generated content.

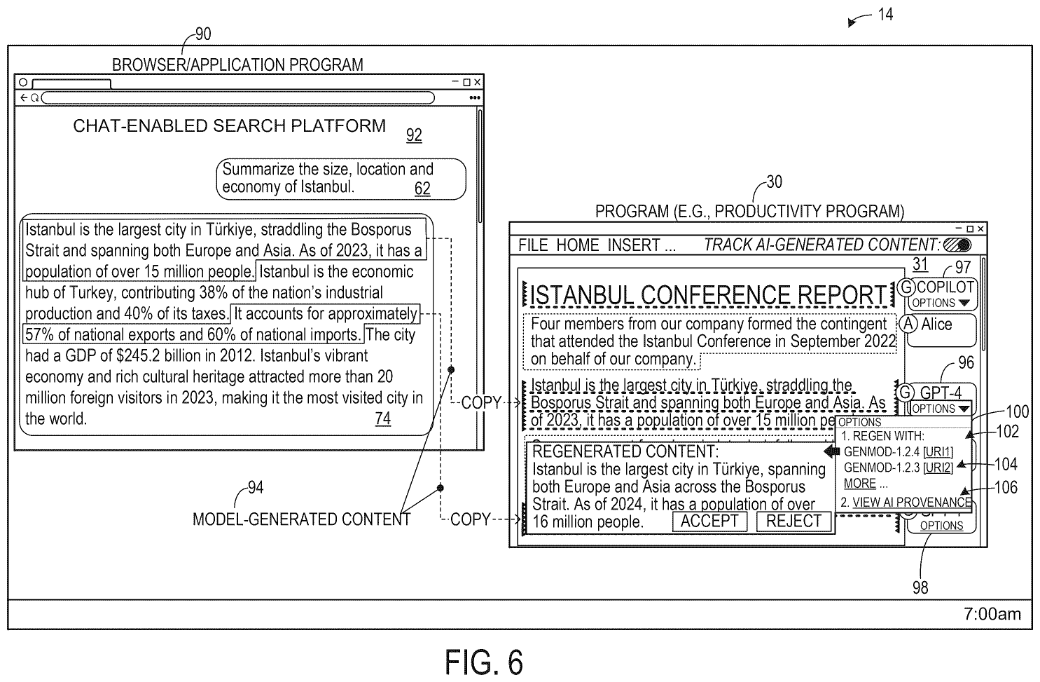

FIG. 5 shows an exemplary browser/application program 90 interaction with program 30. In this example, the browser/application program 90 is displaying the model interface GUI 26 and serves as a source program for model-generated content, and program 30 serves as a destination program capable of receiving provenance-tracked content via an edit operation. As shown, the browser/application program 90 may display as model interface GUI 26 a chat-enabled search platform 92, which is used to provide the input 62 in the form of prompt 42. Further, the browser/application program 90 is configured to receive output 74 in the form of model generated content 16 and associated provenance metadata 18 from the generative model 40 and provenance metadata generation module 60. The model interface GUI 26 displays prompt 42 and model-generated digital content 16 in the chat interface, while the associated provenance metadata 18 is typically not displayed. Alternatively, in the example shown in FIG. 6, a selector 106 labeled “View AI Provenance” can be provided in the model interface GUI 26, to enable a user to selectively display the provenance metadata 18. Returning to FIG. 5, the chat-enabled search platform 92 may permit copying, via an edit operation using a clipboard or other utility executed on the client computing device 14, of portions of the model-generated digital content 16 into program 30. Following the edit operation, when displayed in the program GUI 31 of program 30 the portions of model-generated digital content 16 include formatted digital content 94 including a visual provenance indication 96, 97, 98 labeling the model-generated digital content 16.

As shown in FIG. 6, program 30 is configured to display a plurality of selectable options associated with the displayed visual indication of the model-generated content. For example, in the depicted example, a drop down menu 100 is presented that contains a regeneration option 102 by which a user can select to regenerate the model-generated content 16, and the view AI provenance selector 106 mentioned above. The regeneration option 100 displays a model history 104 with selectable model version entries populated from metadata such as the header metadata 78. The user can select a particular model version from the history 104 to cause the original prompt in header metadata 78 to be transmitted to the selected model version, to regenerate the model-generated content using the selected model version.

In the illustrated example, the AI-generated output 74 comprises, in part, a portion comprising the text “Istanbul is the largest city in Türkiye, straddling the Bosporus Strait and spanning both Europe and Asia. As of 2023, it has a population of over 15 million people.” The method of encoding each character, e.g., via code page Unicode encoding on a per-character basis, allows for new human modifications, additions, or cut and paste to add to and modify the AI-generated content within the program 30, without losing the provenance metadata 18 associated with the copied or modified content, unless the model attribution threshold discussed above is met. As shown in the program 30 in FIG. 5, the copied AI content may be included in, for example, a report, with user/human-generated modifications which are distinguished visually from the AI-generated content. As shown, the AI-generated content 94 copied is shown/displayed highlighted and/or underlined, whereas the human modifications are not highlighted or underlined (as being AI-generated. Additional visual indicators of AI-generated content (such as visual provenance indication labeling 96, 97, 98) are included/displayed, along with the regeneration option 100. The regeneration option 100 is illustrated as a drop down menu 102, but may take other forms such as a pop up or static menu. Selecting the regeneration option 100 with the most recent model version (e.g., “1.2.4. [URI1]”) in the model history 104 causes the program 30 to regenerate the input 62 to the generative model version 1.2.4, to obtain an AI-generated update. In the depicted example, the regenerated content reads, “Istanbul is the largest city in Türkiye, spanning both Europe and Asia across the Bosporus Strait. As of 2024, it has a population of over 16 million people.” As can be seen the original model generated content is rephrased slightly and updated to include latest population figures contained in the selected model. In this way, a regeneration option 100 provides the user of the program 30 with a way to not only track the provenance of the AI-generated content, but also update and revise the AI-generated content via regeneration using the selected model version from model history tracked in the provenance metadata associated with the model-generated digital content.

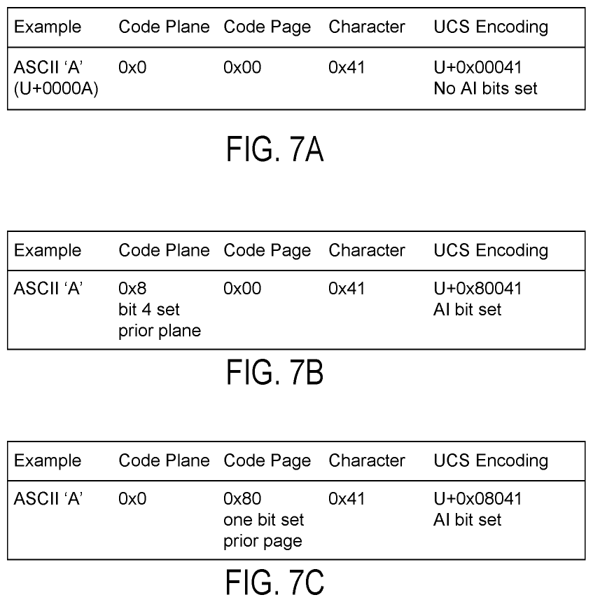

FIGS. 7A, 7B, and 7C illustrate character encoding examples for encoding a capital letter ‘A’. FIG. 7A illustrates an example UCS (i.e., Unicode) encoding of a capital letter ‘A’ as “U+0x00041”, wherein there is no encoding indicating AI-generated content.

FIG. 7B illustrates an example where a bit designating the code plane is set to indicate the character is AI-generated. In particular, the encoding is “U+0x80041”, where the “8” designates the code plane number (i.e., code plane number eight). Each digit in the five digits (comprising “80041”) is a hexadecimal value, which may be represented by four bits. Setting the bit number four from a zero to a one (to create the binary number 1000, or the hex value eight) requires flipping just one bit, shown here as the most significant bit or bit number four. As discussed further below, an encoding scheme (for indicating an AI-generated character) that requires changing just one bit to indicate an AI-generated character, has advantages. For example, a bit mask or bitwise OR operator may be used without disturbing other bits in the encoding for the character. In the example shown in FIG. 4B, bit four is set from a zero to a one (via a provenance metadata generation module such as provenance generation module 60), resulting in a hex value of eight in the code plane digit of the encoding. In one embodiment, when a provenance determination module 12 detects the flipped bit in the code plane encoding digit, the provenance determination module 12 interprets the character to be model-generated and sets the flipped bit off (or back to zero) to interpret the character as a normal UCS (Unicode) encoding, for example, as shown in FIG. 7A. This may also be described as mirroring by preserving the earlier code plane. That is, in the example shown in FIG. 7B, the prior code plane is preserved by setting an AI bit mask (bitwise OR operator) to change/flip bit number four (from zero to one) to indicate an AI-generated character and interpret the character using the prior code plane (i.e., the normal UCS encoding without the changed/flipped bit number four).

FIG. 7C illustrates an example in which a code page bit is set to indicate the character (i.e., capital letter ‘A’) is AI-generated. In particular, the encoding (with indication the character is model-generated) is “U+0x08041”. In one embodiment, when a provenance determination module 12 detects the flipped bit in the encoding, the provenance determination module 12 interprets the character to be model-generated and sets the flipped bit off (or back to zero) to interpret the character in view of the UCS (Unicode) encoding without the flipped bit. This may also be described as mirroring by preserving the earlier code page. In the example shown in FIG. 7C, the prior code page is preserved by setting an AI bit mask (bitwise OR operator) to change/flip a single bit (from zero to one) to indicate an AI-generated character and interpret the character using the prior code page (i.e., without the changed/flipped bit).

A single-byte (eight bit) encoding scheme allows values from 0-255 (or 256 values for an unsigned byte) to be represented. Multi-byte encoding schemes (MBCS) are used to support non-conventional western characters (i.e., ASCII and Extended ASCII) and support global communication. Unicode and the UTF encoding of Unicode may be used for character-by-character encoding. UTF-8 is a common MBCS scheme used on the Internet where only single-byte (ASCII/ANSI) values are conventionally allowed, such as in query strings.

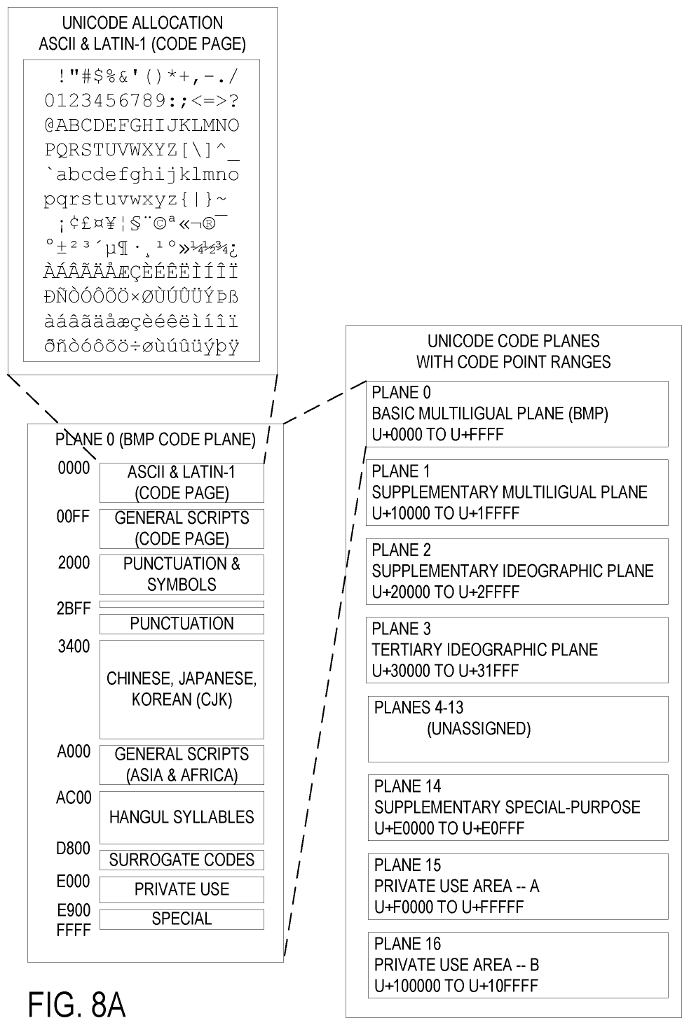

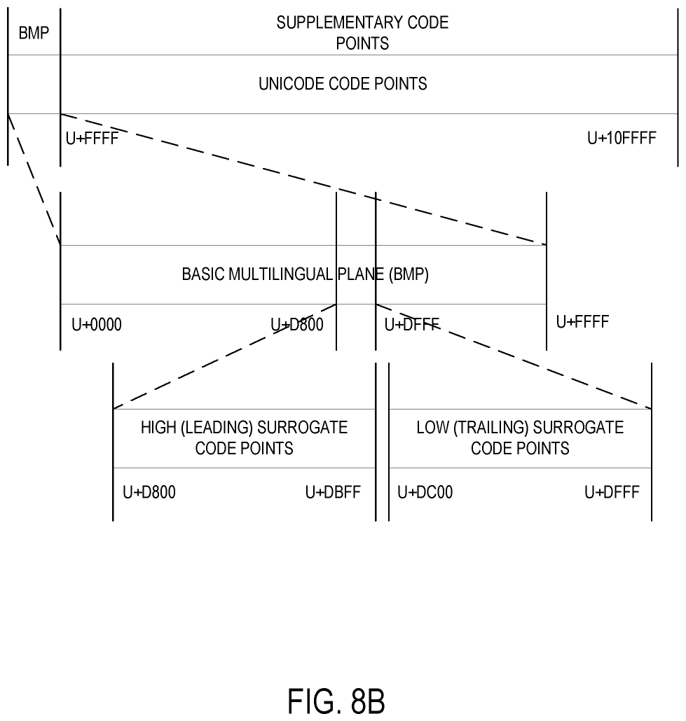

FIG. 8A illustrates an allocation of Unicode code points and a relationship between code pages and code planes. A significant portion of Unicode 2-Byte code pages are unused. Unicode extends the encoding of a character to two (or more) byte values to allow encoding of an entire “page” of characters, known as the code page or code point system, allowing for 65535 encodings of characters in the 2-byte modality. Unicode further extends the code page definitions with code blocks, with defined code planes. As a result, Unicode includes several code pages for “private” or “user-defined” usage. Similarly, less than half of the code-planes are in use. For example, as shown in FIG. 8A, code planes 4-13 are unused. Accordingly, encoding AI-generated characters as described with respect to FIG. 7B allows for use of Unicode code points which are presently unallocated/unused.

For text-based content, the system 10 enables mapping or altering code pages and/or code planes on active content strings to provide provenance metadata 18 (or provenance attribution) per character to the string. As mentioned above with respect to FIGS. 7B and 7C, the alteration can be a single bit change in unused code page or code plane bits, each requiring a different encoding implementation, to “tag” each AI-generated character in a near-invisible fashion to the user. In other embodiments, a set of bits may be used, similarly setting a set of bits using an AI bit mask (bitwise OR operator) without disturbing other bits. In one embodiment, for example, a combination of code plane and code page mapping or altering may be used.

FIG. 8B illustrates an allocation of high and low surrogate code points within the Basic Multilingual Plane (BMP) of the Unicode allocation shown in FIG. 8A. The provenance metadata 18 may include surrogate character encoding or Unicode code plane encoding (such as character encoding with AI indicator 80 as shown in FIG. 2) indicating a model-generated character. As shown in FIG. 8B, Unicode code points have integer values that can range from 0 to U+10FFFF (decimal 1,114,111). Some code points are assigned to letters, symbols, or emoji. Others are assigned to actions that control how text or characters are displayed, such as advance to a new line. Many code points are not yet assigned. The Basic Multilingual Plane (BMP) includes code points in the range U+0000 . . . . U+FFFF and includes high (leading) surrogate code points and low (trailing) surrogate code points, as shown in FIG. 8B. When a high surrogate code point (U+D800 . . . . U+DBFF) is immediately followed by a low surrogate code point (U+DC00 . . . . U+DFFF), the pair is interpreted as a supplementary code point by using a calculation, code point=0x10000+ ((high surrogate code point—0xD800)*0x0400)+(low surrogate code point—0xDC00). However, if an encoding includes just a single surrogate code point, the unpaired surrogate code point may be unrecognized and ignored. Accordingly, in one embodiment, the provenance metadata generation module, such as provenance metadata generation module 60, may include character encoding with an AI indicator that includes a single unpaired surrogate code point, to indicate the character is AI- or model-generated, and to cause a provenance determination module (such as provenance determination module 12) to identify the character as being AI-generated and to interpret the character based on the Unicode encoding without the unpaired surrogate code point.

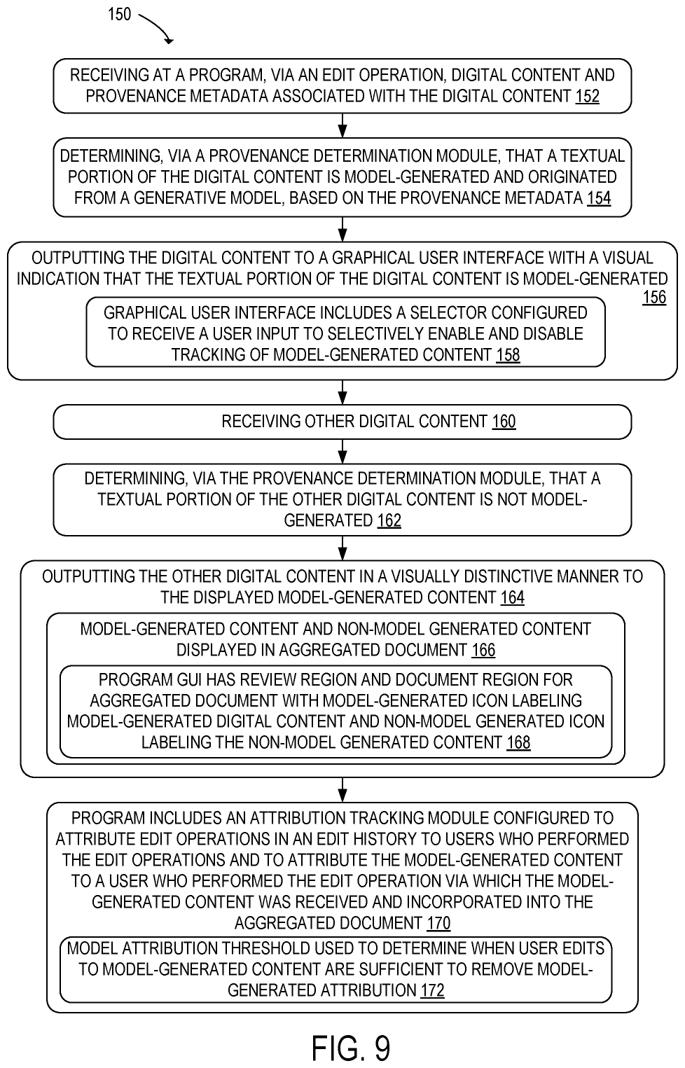

FIG. 9 shows a flow diagram for a computerized method 150 according to one embodiment of the present disclosure. Method 150 may be implemented using the hardware and software components described above, or with other suitable hardware and software components. Method 150 includes, at step 152, receiving at a program executed on processing circuitry, via an edit operation, digital content and provenance metadata associated with the digital content, At step 154, method 150 includes determining, via a provenance determination module, that a textual portion of the digital content is model-generated and originated from a generative model, based on the provenance metadata. At step 156, the method includes outputting the digital content to a graphical user interface with a visual indication that the textual portion of the digital content is model-generated. As shown at step 158, the method can include displaying the graphical user interface to include a selector configured to receive a user input to selectively enable and disable tracking of model-generated content.

At step 160, the method includes receiving other digital content. At step 162, the method includes determining, via the provenance determination module, that a textual portion of the other digital content is not model-generated. At step 164, the method includes outputting the other digital content in a visually distinctive manner to the displayed model-generated content. As shown at 166, the model-generated digital content and non-model-generated other digital content can be incorporated in an aggregated document. Further, as shown at 168, the graphical user interface can includes a document region and a review region and the aggregated document (with the model generated content and the non-model generated content) can be displayed in the document region, and a model-generated icon can be displayed in the review region adjacent the model generated content. Further, a non-model generated icon can be displayed in the review region adjacent the non-model generated content.

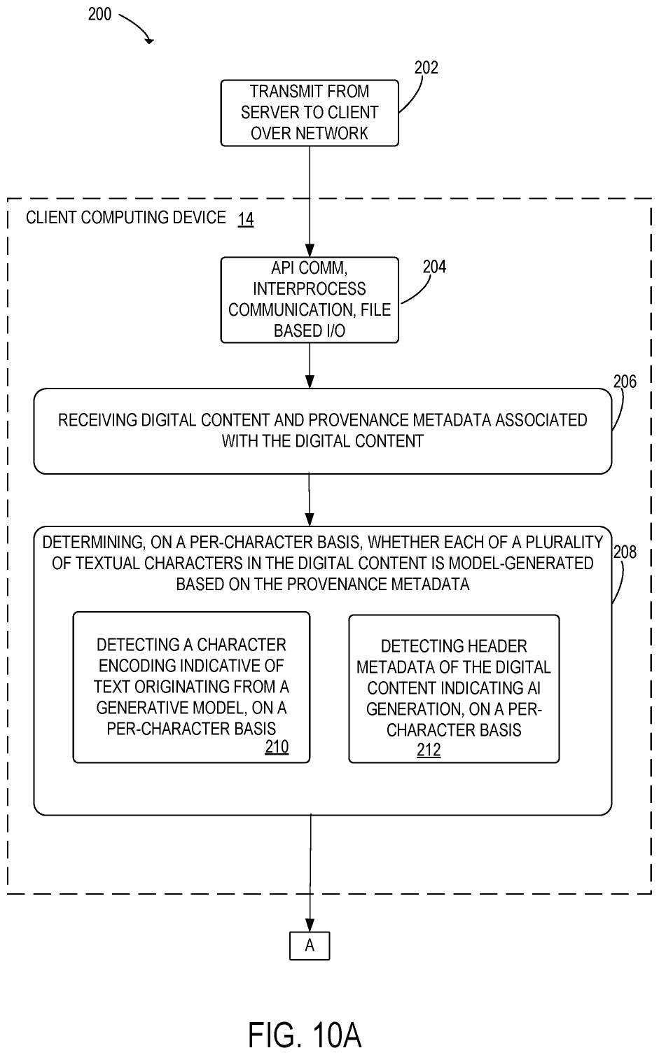

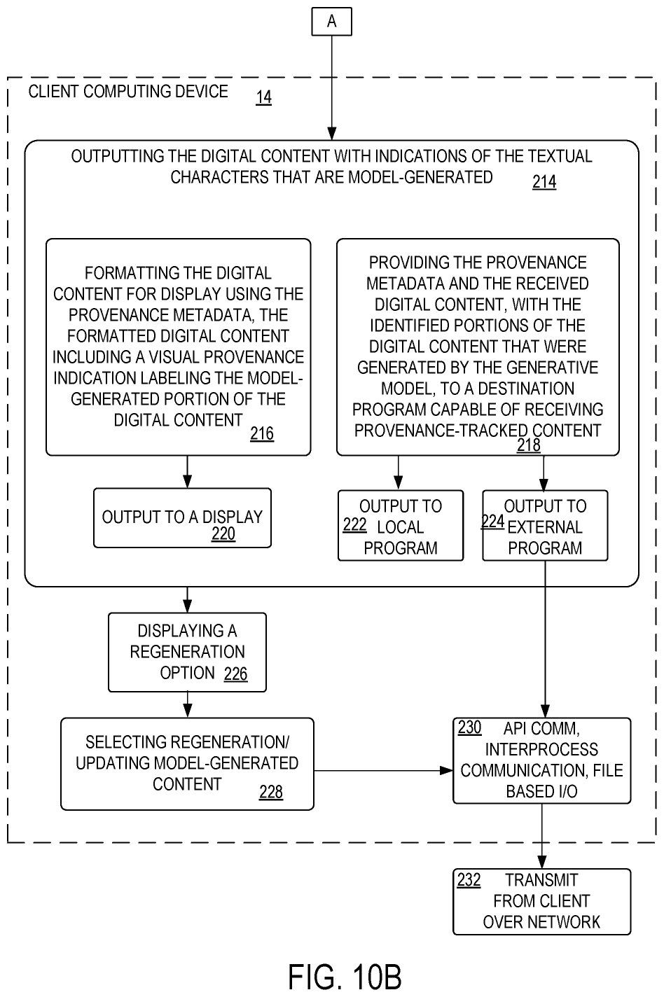

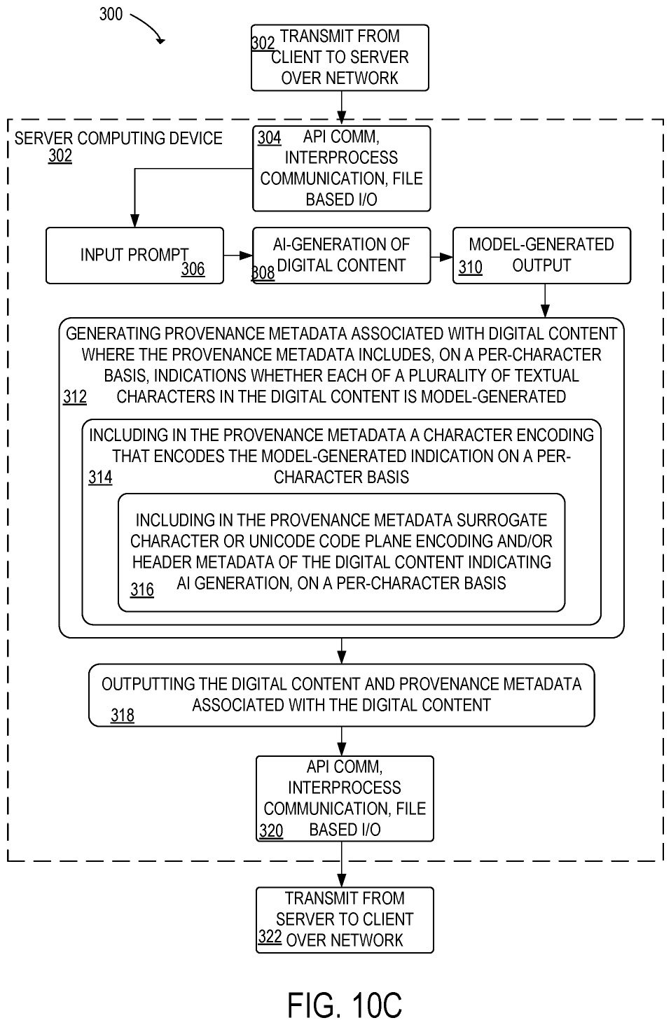

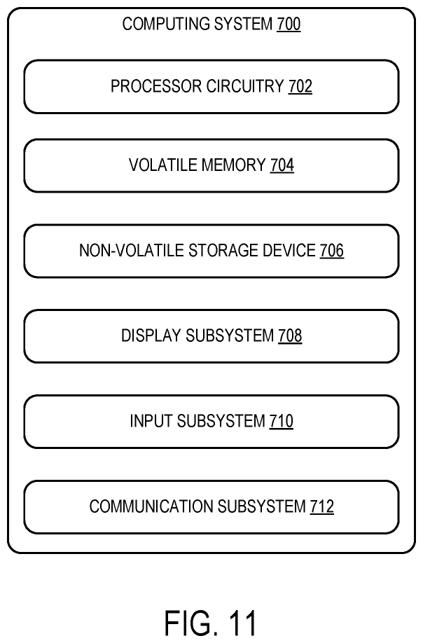

At step 170, the method includes configuring the program with an attribution tracking module to attribute edit operations in an edit history to users who performed the edit operations, and to attribute the model-generated content to a user who performed the edit operation via which the model-generated content was received and incorporated into the aggregated document. At step 172, the method includes configuring the program to include an attribution tracking module with a model attribution threshold, the attribution tracking module being configured to remove a model generated attribution of the model-generated content upon determining that the model generated content has been edited to an extent that the model attribution threshold is no longer met. Further, as discussed in detail in method 200 described in relation to FIGS. 10A-10C below, determining at step 154 can includes determining, on a per-character, basis whether each of a plurality of textual characters in the digital content is model generated. Other features and steps of methods 200 and 300 can be combined with the steps of method 150, as desired.

FIGS. 10A and 10B show a flow diagram for an example method 200 for receiving digital content and provenance metadata associated with the digital content, and outputting the digital content with indications of the textual characters that are model-generated, according to embodiments. Method 200 may be implemented using the hardware and software components described above, or with other suitable hardware and software components. At step 202, the method includes transmitting digital content and provenance metadata associated with the digital content from a server computing device to a client computing device 14 over a communication network. At step 204, the method further includes communication with an API communication interface, interprocess communication, and file I/O protocols.

At step 206, the method further includes receiving digital content and provenance metadata associated with the digital content. At step 208, the method further includes determining, on a per-character basis, whether each of a plurality of textual characters in the digital content is model-generated based on the provenance metadata.

Steps 210-214 of the method 200 may be performed on the client computing device 14. At step 210, the method includes detecting a character encoding indicative of text originating from a generative model, on a per-character basis. At step 212, the method includes detecting metadata such as header metadata of the digital content indicating AI generation, on a per-character basis. At step 214, the method includes outputting the digital content with indications of the textual characters that are model-generated.

Steps 216, 218, 220, 222, and 224 can be performed at the client computing device 14 as part of step 214. At step 216, the method includes formatting the digital content for display using the provenance metadata, the formatted digital content including a visual provenance indication labeling the model-generated portion of the digital content, and outputting the formatted digital content including the visual provenance indication to a display. At step 218, the method includes providing the provenance metadata and the received digital content, with the identified portions of the digital content that were generated by the generative model, to a destination program capable of receiving provenance-tracked content.

At step 220, the method includes outputting the formatted digital content including the visual provenance indication to a display. At step 222, the method includes outputting the provenance metadata and the received digital content, with the identified portions of the digital content that were generated by the generative model, to a local program. At step 224, the method includes outputting the provenance metadata and the received digital content, with the identified portions of the digital content that were generated by the generative model, to an external program via step 230, which includes communication with an API communication interface, interprocess communication, and file I/O protocols.

Step 226 follows completion of step 214 and includes displaying a regeneration option on the client computing device 14, with the regeneration option permitting regeneration of the textual characters that are model-generated using the model version and/or the model history, along with the indications of model generated content within the digital content, and the provenance metadata comprises model version, model history, and/or prompts or prompt-related context used to generate the portions of the digital content generated by a generative model.

At step 228, the method includes selecting the regeneration option. At step 230, the method includes communication with an API communication interface, interprocess communication, and file I/O protocols. At step 232, the method includes transmitting digital content and provenance metadata associated with the digital content from the client computing device 14 over a communication network.

FIG. 10C shows a flow diagram for an example method 300 for generating provenance metadata associated with digital content where the provenance metadata includes indications whether each character is model-generated, and outputting the digital content and provenance metadata associated with the digital content, according to embodiments. Method 300 may be implemented using the hardware and software components described above, or with other suitable hardware and software components. At step 302, the method includes transmitting input prompt from client to server device over a communication network. At step 304, the method further includes communication with an API communication interface, interprocess communication, and file I/O protocols.

At step 306, the method includes sending an input prompt to a generative model for generation of model-generated digital content. At step 308, the method includes generation of model-generated digital content. At step 310, the method includes receiving the model-generative digital content from the generative model for generation of provenance metadata associated with the digital content. At step 312, the model includes generating provenance metadata associated with digital content where the provenance metadata includes, on a per-character basis, indications whether each of a plurality of textual characters in the digital content is model-generated. At step 314, the model includes including a character encoding that encodes the model-generated indication on a per-character basis.

At step 316, the model includes including surrogate character or Unicode code plane encoding and/or metadata such as header metadata of the digital content indicating AI generation, on a per-character basis. At step 318, the model includes outputting the digital content and provenance metadata associated with the digital content. At step 320, the method further includes communication with an API communication interface, interprocess communication, and file I/O protocols. At step 322, the model includes transmitting the digital content and provenance metadata associated with the digital content from the server computing device 302 over a communications network.

Using the devices and methods discussed above, tracking the provenance of AI-generated content is enabled via generation of provenance metadata that can be detected by a destination program capable of receiving provenance-tracked content. The above-described devices and methods provide encoding whether textual digital content is model-generated, for example on a per-character basis and with additional information such as creation date, model used, and prompts used for the model-generated content. Applications/programs may thereby identify model-generated content (e.g., on a character-by-character/per-character basis) and also continue to render and handle the (model- and user-generated) content for the user without requiring the user to operate the program in any special manner when performing edit operations. In this way, identification of model-generated content within the context of non-model-generated text is enabled, safety and security is improved, and the utility and value of generative models can be improved due to the avoidance of model-collapse scenarios (where generative models train on model-generated data). By using provenance metadata that is digitally signed and/or passes an attestation test, the security and integrity of the determination that content is model-generated can be improved.

In some embodiments, the methods and processes described herein may be tied to a computing system of one or more computing devices. In particular, such methods and processes may be implemented as a computer-application program or service, an application-programming interface (API), a library, and/or other computer-program product.

FIG. 7 schematically shows a non-limiting embodiment of a computing system 700 that can enact one or more of the methods and processes described above. Computing system 700 is shown in simplified form. Computing system 700 may embody the computing system 10 described above and illustrated in FIGS. 1, 2, 5, and FIGS. 6A-6C. Components of computing system 700 may be included in one or more personal computers, server computers, tablet computers, home-entertainment computers, network computing devices, video game devices, mobile computing devices, mobile communication devices (e.g., smartphone), and/or other computing devices, and wearable computing devices such as smart wristwatches and head mounted augmented reality devices.

Computing system 700 includes processing circuitry 702, volatile memory 704, and a non-volatile storage device 706. Computing system 700 may optionally include a display subsystem 708, input subsystem 710, communication subsystem 712, and/or other components not shown in FIG. 7.

Processing circuitry typically includes one or more logic processors, which are physical devices configured to execute instructions. For example, the logic processors may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors configured to execute software instructions. Additionally or alternatively, the logic processor may include one or more hardware logic circuits or firmware devices configured to execute hardware-implemented logic or firmware instructions. Processors of the processing circuitry 702 may be single-core or multi-core, and the instructions executed thereon may be configured for sequential, parallel, and/or distributed processing. Individual components of the processing circuitry optionally may be distributed among two or more separate devices, which may be remotely located and/or configured for coordinated processing. For example, aspects of the computing system disclosed herein may be virtualized and executed by remotely accessible, networked computing devices configured in a cloud-computing configuration. In such a case, these virtualized aspects are run on different physical logic processors of various different machines, it will be understood. These different physical logic processors of the different machines will be understood to be collectively encompassed by processing circuitry 702.

Non-volatile storage device 706 includes one or more physical devices configured to hold instructions executable by the processing circuitry to implement the methods and processes described herein. When such methods and processes are implemented, the state of non-volatile storage device 1006 may be transformed—e.g., to hold different data.

Non-volatile storage device 706 may include physical devices that are removable and/or built in. Non-volatile storage device 706 may include optical memory, semiconductor memory, and/or magnetic memory, or other mass storage device technology. Non-volatile storage device 706 may include nonvolatile, dynamic, static, read/write, read-only, sequential-access, location-addressable, file-addressable, and/or content-addressable devices. It will be appreciated that non-volatile storage device 706 is configured to hold instructions even when power is cut to the non-volatile storage device 706.

Volatile memory 704 may include physical devices that include random access memory. Volatile memory 704 is typically utilized by processing circuitry 702 to temporarily store information during processing of software instructions. It will be appreciated that volatile memory 704 typically does not continue to store instructions when power is cut to the volatile memory 704.

Aspects of processing circuitry 702, volatile memory 704, and non-volatile storage device 706 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 700 typically implemented in software by a processor to perform a particular function using portions of volatile memory, which function involves transformative processing that specially configures the processor to perform the function. Thus, a module, program, or engine may be instantiated via processing circuitry 702 executing instructions held by non-volatile storage device 706, using portions of volatile memory 704. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 708 may be used to present a visual representation of data held by non-volatile storage device 706. The visual representation may take the form of a graphical user interface (GUI). As the herein described methods and processes change the data held by the non-volatile storage device, and thus transform the state of the non-volatile storage device, the state of display subsystem 708 may likewise be transformed to visually represent changes in the underlying data. Display subsystem 708 may include one or more display devices utilizing virtually any type of technology. Such display devices may be combined with processing circuitry 702, volatile memory 704, and/or non-volatile storage device 706 in a shared enclosure, or such display devices may be peripheral display devices.

When included, input subsystem 710 may comprise or interface with one or more user-input devices such as a keyboard, mouse, touch screen, camera, or microphone.

When included, communication subsystem 712 may be configured to communicatively couple various computing devices described herein with each other, and with other devices. Communication subsystem 712 may include wired and/or wireless communication devices compatible with one or more different communication protocols. As non-limiting examples, the communication subsystem may be configured for communication via a wired or wireless local- or wide-area network, broadband cellular network, etc. In some embodiments, the communication subsystem may allow computing system 700 to send and/or receive messages to and/or from other devices via a network such as the Internet.

Additional aspects of the present disclosure are described below. According to a first aspect, a computing system for tracking provenance of model-generated content is provided, comprising processing circuitry and associated memory, the processing circuitry being configured to implement a program using portions of the associated memory, to receive, via an edit operation, digital content and provenance metadata associated with the digital content, determine, via a provenance determination module, that a textual portion of the digital content is model-generated and originated from a generative model, based on the provenance metadata, and output the digital content to a graphical user interface with a visual indication that the textual portion of the digital content is model-generated.

In this aspect, the program can be further configured to receive other digital content, determine, via the provenance determination module, that a textual portion of the other digital content is not model-generated, and output the other digital content in a visually distinctive manner to the displayed model-generated content.

In this aspect, the model-generated digital content and non-model-generated other digital content can be incorporated in an aggregated document.

In this aspect, the graphical user interface can includes a document region and a review region and the aggregated document with the model generated content and the non-model generated content can be displayed in the document region and a model-generated icon can be displayed in the review region adjacent the model generated content.

In this aspect, a non-model generated icon can be displayed in the review region adjacent the non-model generated content.

In this aspect, the graphical user interface can include a selector configured to receive a user input to selectively enable and disable tracking of model-generated content.

In this aspect, the program can includes an attribution tracking module configured to attribute edit operations in an edit history to users who performed the edit operations, and the attribution tracking module can be configured to attribute the model-generated content to a user who performed the edit operation via which the model-generated content was received and incorporated into the aggregated document.

In this aspect, the program can include an attribution tracking module configured with a model attribution threshold, the attribution tracking module being configured to remove a model generated attribution of the model-generated content upon determining that the model generated content has been edited to an extent that the model attribution threshold is no longer met.

In this aspect, determining can include determining, on a per-character, basis whether each of a plurality of textual characters in the digital content is model generated.

In this aspect, the provenance metadata can include a character encoding that encodes the indication of the model-generated textual characters on a per-character basis.

In this aspect, the provenance metadata can comprise surrogate character encoding or Unicode code plane encoding indicating the model-generated textual characters.

In this aspect, the processing circuitry and memory can be incorporated in a client computing device, and the provenance metadata has been generated by a provenance metadata generation module executed on a server computing device, from which the digital content was received.

In this aspect, the server computing device can be a generative model server, or the server computing device can be a model interface server configured to execute a model interface, the model interface being configured to interface with the generative model on the generative model server.

In this aspect, the program can be configured to output the digital content with an indication of the textual portion that is model-generated, at least in part by: formatting the digital content for display using the provenance metadata, the formatted digital content including a visual provenance indication labeling the model-generated digital content, and outputting the formatted digital content including the visual provenance indication to a display.

Further in this aspect, the program can be configured to receive the digital content from a copilot interface provided in a productivity application, a browser, a social media application, or a game program executed by the processing circuitry; an instance of a generative model associated with a model interface GUI displayed by the processing circuitry; a model interface associated with the model interface GUI displayed by the processing circuitry; a clipboard program executed by the processing circuitry; or a document.

Further in this aspect, the provenance metadata can include a creation date, a model version identifier, and/or prompt used to generate the portion of the digital content.

Further in this aspect, the provenance metadata can be encrypted and/or digitally signed and stored in a manifest associated with the document.

Further in this aspect, the provenance determination module can be configured to make the provenance determination by detecting a character encoding indicative of text originating from a generative model, on a per-character basis.

Further in this aspect, the provenance determination module can be configured to make the provenance determination by detecting metadata of the digital content indicating AI generation.

Further in this aspect, the provenance determination module can read attestation data in a manifest that is encrypted and/or signed by a digital signature to verify a source of the model-generated digital content.

In this aspect, the provenance metadata can include license information.

In this aspect, the provenance metadata can comprise model version, model history, and/or prompts or prompt-related context used to generate the portions of the digital content generated by a generative model.

In this aspect, the program can be configured to display a regeneration option using the model version and the model history, along with the indications of model generated content within the digital content.

According to another aspect, a computerized method for tracking provenance of model generated content, is provided, comprising: receiving at a program executed on processing circuitry, via an edit operation, digital content and provenance metadata associated with the digital content; determining, via a provenance determination module, that a textual portion of the digital content is model-generated and originated from a generative model, based on the provenance metadata; and outputting the digital content to a graphical user interface with a visual indication that the textual portion of the digital content is model-generated.

In this aspect, the method can further comprise: receiving other digital content; determining, via the provenance determination module, that a textual portion of the other digital content is not model-generated; and outputting the other digital content in a visually distinctive manner to the displayed model-generated content.

In this aspect, the model-generated digital content and non-model-generated other digital content can be incorporated in an aggregated document.

In this aspect, the graphical user interface can include a document region and a review region and the aggregated document with the model generated content and the non-model generated content can be displayed in the document region and a model-generated icon can be displayed in the review region adjacent the model generated content.

In this aspect, a non-model generated icon can be displayed in the review region adjacent the non-model generated content.

In this aspect, wherein the graphical user interface includes a selector configured to receive a user input to selectively enable and disable tracking of model-generated content.

In this aspect, the program can include an attribution tracking module configured to attribute edit operations in an edit history to users who performed the edit operations, and the attribution tracking module can be configured to attribute the model-generated content to a user who performed the edit operation via which the model-generated content was received and incorporated into the aggregated document.

In this aspect, the program can include an attribution tracking module configured with a model attribution threshold, the attribution tracking module being configured to remove a model generated attribution of the model-generated content upon determining that the model generated content has been edited to an extent that the model attribution threshold is no longer met.

In this aspect, determining can include determining, on a per-character, basis whether each of a plurality of textual characters in the digital content is model generated.

In this aspect, the provenance metadata can include a character encoding that encodes the indication of the model-generated textual characters on a per-character basis.

In this aspect, the provenance metadata can comprise surrogate character encoding or Unicode code plane encoding indicating the model-generated textual characters.

In this aspect, the processing circuitry and memory may be incorporated in a client computing device, and the provenance metadata may have been generated by a provenance metadata generation module executed on a server computing device, from which the digital content was received.

In this aspect, the server computing device can be a generative model server, or the server computing device can be a model interface server configured to execute a model interface, the model interface being configured to interface with the generative model on the generative model server.

In this aspect, the program can be configured to output the digital content with an indication of the textual portion that is model-generated, at least in part by: formatting the digital content for display using the provenance metadata, the formatted digital content including a visual provenance indication labeling the model-generated digital content, and outputting the formatted digital content including the visual provenance indication to a display.

In this aspect, the program can be configured to receive the digital content from: a copilot interface provided in a productivity application, a browser, a social media application, or a game program executed by the processing circuitry; an instance of a generative model associated with a model interface GUI displayed by the processing circuitry; a model interface associated with the model interface GUI displayed by the processing circuitry; a clipboard program executed by the processing circuitry; or a document.

In this aspect, the provenance metadata can include a creation date, a model version identifier, and/or prompt used to generate the portion of the digital content.

In this aspect, the provenance metadata can be encrypted and/or digitally signed and stored in a manifest associated with the document.

In this aspect, the provenance determination module can be configured to make the provenance determination by detecting a character encoding indicative of text originating from a generative model, on a per-character basis.

In this aspect, the provenance determination module can be configured to make the provenance determination by detecting metadata of the digital content indicating AI generation.

In this aspect, the provenance determination module can read attestation data in a manifest that is encrypted and/or signed by a digital signature to verify a source of the model-generated digital content.

In this aspect, the provenance metadata can include license information.

In this aspect, the provenance metadata can comprise model version, model history, and/or prompts or prompt-related context used to generate the portions of the digital content generated by a generative model.

In this aspect, the program can be configured to display a regeneration option using the model version and the model history, along with the indications of model generated content within the digital content.

According to another aspect, a computing system is provided, comprising processing circuitry and associated memory, the processing circuitry being configured to, at a first program module: receive digital content and provenance metadata associated with the digital content at a model interface GUI of a generative model; perform an edit operation on a portion of the digital content to thereby produce an operation output; and maintain the provenance metadata associated with the portion of the digital content in the operation output. The processing circuitry is further configured to at, a second program module: receive the operation output; determine whether the portion of the digital content is model-generated based on the provenance metadata; and output the digital content with indications of the portion that is model-generated.

According to another aspect, a computing system is provided, comprising: processing circuitry and associated memory, the processing circuitry being configured to implement a provenance determination module, to: receive digital content and provenance metadata associated with the digital content; determine, on a per-character basis, whether each of a plurality of textual characters in the digital content is model-generated based on the provenance metadata, the model-generated textual characters having been generated by a generative model; and output the digital content with indications of the textual characters that are model-generated.

According to another aspect, a computerized method is provided, comprising: receiving digital content and provenance metadata associated with the digital content; determining, on a per-character basis, whether each of a plurality of textual characters in the digital content is model-generated based on the provenance metadata. the model-generated textual characters having been generated by a generative model; and outputting the digital content with indications of the textual characters that are model-generated.

According to another aspect, a computerized method is provided, comprising: generating provenance metadata associated with digital content, where the provenance metadata includes, on a per-character basis, indications whether each of a plurality of textual characters in the digital content is model-generated, wherein the provenance metadata further includes a character encoding that encodes the model-generated indication on a per-character basis, and the provenance metadata includes surrogate character or Unicode code plane encoding and/or metadata of the digital content indicating AI generation, on a per-character basis; and outputting the digital content and provenance metadata associated with the digital content.

“And/or” as used herein is defined as the inclusive or V, as specified by the following truth table:

| A | B | A V B |
|---|---|---|
| True | True | True |
| True | False | True |
| False | True | True |
| False | False | False |

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system for tracking provenance of model-generated content, comprising:
processing circuitry and associated memory, the processing circuitry being configured to implement a program using portions of the associated memory, to:
receive, via an edit operation, digital content and provenance metadata associated with the digital content;
determine, via a provenance determination module, that a textual portion of the digital content is model-generated and originated from a generative model, based on the provenance metadata; and
output the digital content to a graphical user interface with a visual indication that the textual portion of the digital content is model-generated.

2. The computing system of claim 1, wherein the program is further configured to:
receive other digital content;
determine, via the provenance determination module, that a textual portion of the other digital content is not model-generated; and
output the other digital content in a visually distinctive manner to the displayed model-generated content.

3. The computing system of claim 2, wherein the model-generated digital content and non-model-generated other digital content are incorporated in an aggregated document.

4. The computing system of claim 3, wherein the graphical user interface includes a document region and a review region and the aggregated document with the model generated content and the non-model generated content is displayed in the document region and a model-generated icon is displayed in the review region adjacent the model generated content.

5. The computing system of claim 4, wherein a non-model generated icon is displayed in the review region adjacent the non-model generated content.

6. The computing system of claim 1, wherein the graphical user interface includes a selector configured to receive a user input to selectively enable and disable tracking of model-generated content.

7. The computing system of claim 1, wherein
the program includes an attribution tracking module configured to attribute edit operations in an edit history to users who performed the edit operations, and
the attribution tracking module is configured to attribute the model-generated content to a user who performed the edit operation via which the model-generated content was received and incorporated into the aggregated document.

8. The computing system of claim 1, wherein the program includes an attribution tracking module configured with a model attribution threshold, the attribution tracking module being configured to remove a model generated attribution of the model-generated content upon determining that the model generated content has been edited to an extent that the model attribution threshold is no longer met.

9. The computing system of claim 1, wherein determining includes determining, on a per-character, basis whether each of a plurality of textual characters in the digital content is model generated.

10. The computing system of claim 1, wherein the provenance metadata includes a character encoding that encodes the indication of the model-generated textual characters on a per-character basis.

11. The computing system of claim 10, wherein the provenance metadata comprises surrogate character encoding or Unicode code plane encoding indicating the model-generated textual characters.

12. The computing system of claim 11, wherein
the processing circuitry and memory are incorporated in a client computing device, and
the provenance metadata has been generated by a provenance metadata generation module executed on a server computing device, from which the digital content was received.

13. The computing system of claim 12, wherein
the server computing device is a generative model server, or
the server computing device is a model interface server configured to execute a model interface, the model interface being configured to interface with the generative model on the generative model server.

14. The computing system of claim 1, wherein the program is configured to output the digital content with an indication of the textual portion that is model-generated, at least in part by:
formatting the digital content for display using the provenance metadata, the formatted digital content including a visual provenance indication labeling the model-generated digital content, and
outputting the formatted digital content including the visual provenance indication to a display.

15. The computing system of claim 1, wherein the program is configured to receive the digital content from:
a copilot interface provided in a productivity application, a browser, a social media application, or a game program executed by the processing circuitry,
an instance of a generative model associated with a model interface GUI displayed by the processing circuitry,
a model interface associated with the model interface GUI displayed by the processing circuitry,
a clipboard program executed by the processing circuitry, or
a document.

16. The computing system of claim 1, wherein the provenance metadata includes a creation date, a model version identifier, and/or prompt used to generate the portion of the digital content.

17. The computing system of claim 1, wherein the provenance metadata is encrypted and/or digitally signed and stored in a manifest associated with the document.

18. The computing system of claim 1, wherein the provenance determination module is configured to make the provenance determination by detecting a character encoding indicative of text originating from a generative model, on a per-character basis.

19. The computing system of claim 1, wherein the provenance determination module is configured to make the provenance determination by detecting metadata of the digital content indicating AI generation.

20. The computing system of claim 1, wherein the provenance determination module reads attestation data in a manifest that is encrypted and/or signed by a digital signature to verify a source of the model-generated digital content.

21. The computing system of claim 1, wherein the provenance metadata includes license information.

22. The computing system of claim 1, wherein the provenance metadata comprises model version, model history, and/or prompts or prompt-related context used to generate the portions of the digital content generated by a generative model.

23. The computing system of claim 22, wherein the program is configured to display a regeneration option using the model version and the model history, along with the indications of model generated content within the digital content.

24. A computerized method for tracking provenance of model generated content, comprising:
receiving at a program executed on processing circuitry, via an edit operation, digital content and provenance metadata associated with the digital content;
determining, via a provenance determination module, that a textual portion of the digital content is model-generated and originated from a generative model, based on the provenance metadata; and
outputting the digital content to a graphical user interface with a visual indication that the textual portion of the digital content is model-generated.

25. The computerized method of claim 24, further comprising:
receiving other digital content;
determining, via the provenance determination module, that a textual portion of the other digital content is not model-generated; and
outputting the other digital content in a visually distinctive manner to the displayed model-generated content.

26. The computerized method of claim 25, wherein the model-generated digital content and non-model-generated other digital content are incorporated in an aggregated document.

27. The computerized method of claim 26, wherein the graphical user interface includes a document region and a review region and the aggregated document with the model generated content and the non-model generated content is displayed in the document region and a model-generated icon is displayed in the review region adjacent the model generated content.

28. The computerized method of claim 24, wherein a non-model generated icon is displayed in the review region adjacent the non-model generated content.

29. The computerized method of claim 24, wherein the graphical user interface includes a selector configured to receive a user input to selectively enable and disable tracking of model-generated content.

30. The computerized method of claim 24, wherein
the program includes an attribution tracking module configured to attribute edit operations in an edit history to users who performed the edit operations, and
the attribution tracking module is configured to attribute the model-generated content to a user who performed the edit operation via which the model-generated content was received and incorporated into the aggregated document.

31. The computerized method of claim 24, wherein the program includes an attribution tracking module configured with a model attribution threshold, the attribution tracking module being configured to remove a model generated attribution of the model-generated content upon determining that the model generated content has been edited to an extent that the model attribution threshold is no longer met.

32. The computerized method of claim 24, wherein determining includes determining, on a per-character, basis whether each of a plurality of textual characters in the digital content is model generated.

33. The computerized method of claim 24, wherein the provenance metadata includes a character encoding that encodes the indication of the model-generated textual characters on a per-character basis.

34. The computerized method of claim 24, wherein the provenance metadata comprises surrogate character encoding or Unicode code plane encoding indicating the model-generated textual characters.

35. The computerized method of claim 24, wherein
the processing circuitry and memory are incorporated in a client computing device, and
the provenance metadata has been generated by a provenance metadata generation module executed on a server computing device, from which the digital content was received.

36. The computerized method of claim 24, wherein
the server computing device is a generative model server, or
the server computing device is a model interface server configured to execute a model interface, the model interface being configured to interface with the generative model on the generative model server.

37. The computerized method of claim 24, wherein the program is configured to output the digital content with an indication of the textual portion that is model-generated, at least in part by:
formatting the digital content for display using the provenance metadata, the formatted digital content including a visual provenance indication labeling the model-generated digital content, and
outputting the formatted digital content including the visual provenance indication to a display.

38. The computerized method of claim 24, wherein the program is configured to receive the digital content from:
a copilot interface provided in a productivity application, a browser, a social media application, or a game program executed by the processing circuitry,
an instance of a generative model associated with a model interface GUI displayed by the processing circuitry,
a model interface associated with the model interface GUI displayed by the processing circuitry,
a clipboard program executed by the processing circuitry, or
a document.

39. The computerized method of claim 24, wherein the provenance metadata includes a creation date, a model version identifier, and/or prompt used to generate the portion of the digital content.

40. The computerized method of claim 24, wherein the provenance metadata is encrypted and/or digitally signed and stored in a manifest associated with the document.

41. The computerized method of claim 24, wherein the provenance determination module is configured to make the provenance determination by detecting a character encoding indicative of text originating from a generative model, on a per-character basis.

42. The computerized method of claim 24, wherein the provenance determination module is configured to make the provenance determination by detecting metadata of the digital content indicating AI generation.

43. The computerized method of claim 24, wherein the provenance determination module reads attestation data in a manifest that is encrypted and/or signed by a digital signature to verify a source of the model-generated digital content.

44. The computerized method of claim 24, wherein the provenance metadata includes license information.

45. The computerized method of claim 24, wherein the provenance metadata comprises model version, model history, and/or prompts or prompt-related context used to generate the portions of the digital content generated by a generative model.

46. The computerized method of claim 45, wherein the program is configured to display a regeneration option using the model version and the model history, along with the indications of model generated content within the digital content.

47. A computing system, comprising:
processing circuitry and associated memory, the processing circuitry being configured to:
at a first program module:
receive digital content and provenance metadata associated with the digital content at a model interface GUI of a generative model;
perform an edit operation on a portion of the digital content to thereby produce an operation output;
maintain the provenance metadata associated with the portion of the digital content in the operation output;
at a second program module:
receive the operation output;
determine whether the portion of the digital content is model-generated based on the provenance metadata; and
output the digital content with indications of the portion that is model-generated.

48. A computing system, comprising:
processing circuitry and associated memory, the processing circuitry being configured to implement a provenance determination module, to:
receive digital content and provenance metadata associated with the digital content;
determine, on a per-character basis, whether each of a plurality of textual characters in the digital content is model-generated based on the provenance metadata, the model-generated textual characters having been generated by a generative model; and
output the digital content with indications of the textual characters that are model-generated.

49. A computerized method, comprising:
receiving digital content and provenance metadata associated with the digital content;
determining, on a per-character basis, whether each of a plurality of textual characters in the digital content is model-generated based on the provenance metadata. the model-generated textual characters having been generated by a generative model; and
outputting the digital content with indications of the textual characters that are model-generated.

50. A computerized method, comprising:
generating provenance metadata associated with digital content where the provenance metadata includes, on a per-character basis, indications whether each of a plurality of textual characters in the digital content is model-generated,
wherein
the provenance metadata includes a character encoding that encodes the model-generated indication on a per-character basis, and
the provenance metadata includes surrogate character or Unicode code plane encoding and/or metadata of the digital content indicating AI generation, on a per-character basis; and
outputting the digital content and provenance metadata associated with the digital content.
